(19) United States
(12) Patent Application Publication
(10) Pub. No.: US 2025/0008445 A1
(43) Pub. Date: Jan. 2, 2025

(54) SYSTEMS AND METHODS FOR POWER MANAGEMENT IN A REMOTE UNIT

(71) Applicant: CORNING RESEARCH & DEVELOPMENT CORPORATION, Corning, NY (US)

(72) Inventor: Yona Henia, Mazkeret Batya (IL)

(21) Appl. No.: 18/216,136

(22) Filed: Jun. 29, 2023

(51) Int. Cl. H04W 52/02

(52) U.S. Cl. CPC H04W 52/0274; H04W 52/0245

(57) ABSTRACT

Systems and methods for power management in a remote unit are disclosed. In one aspect, a control circuit may evaluate parameters and turn off portions of an antenna array associated with the remote unit. Exemplary parameters include signal strengths of active user equipment in a coverage area, a total number of active user equipment, and/or actual signal traffic being generated by/for the active user equipment. Based on one or more of these parameters, certain ones of the antennas and associated transceiver circuitry for the antenna array may be put into a low power or sleep mode. Given that an antenna array may include on the order of sixty-four antennas, and aspects of the present disclosure may put up to half the antennas in the low power mode, substantial power savings may be achieved.

### BACKGROUND

The technology of the disclosure relates generally to remote units in a distributed communication system (DCS) and, more particularly, to managing power within such remote units.

Computing devices abound in modern society, and more particularly, mobile communication devices have become increasingly common. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences. With the advent of the myriad functions available to such devices, there has been increased pressure to provide wireless networks through which such devices may communicate to utilize the full spectrum of such functions.

This pressure has given rise to DCS, which extend wireless networks to regions where cellular and other wireless coverage may be limited, such as inside buildings. In most such DCS, there is a central unit with a plurality of remote units distributed throughout the building. In some instances, the remote units may have local power supplies, and in other instances, power may be supplied through a power distribution network tied to the DCS. In either event, there is general pressure to make power-consuming equipment more environmentally friendly by reducing power consumption. At the same time, emerging technologies are requiring increasing power levels as a function of higher bandwidth requirements, higher constellations, and the like. This tension between a desire to reduce power consumption and the increased power demands creates the opportunity for innovation.

### SUMMARY

Aspects disclosed in the detailed description include systems and methods for power management in a remote unit. In particular, exemplary aspects of the present disclosure contemplate evaluating parameters and turning off portions of an antenna array associated with the remote unit. Exemplary parameters include signal strengths of active user equipment in a coverage area, a total number of active user equipment, and/or actual signal traffic being generated by/for the active user equipment. Based on one or more of these parameters, certain ones of the antennas and associated transceiver circuitry for the antenna array may be put into a low power or sleep mode. Given that an antenna array may include on the order of sixty-four antennas, and aspects of the present disclosure may put up to half the antennas in the low power mode, substantial power savings may be achieved.

In this regard, in one aspect, a method of saving power in a distributed communication system (DCS) is disclosed. The method includes determining if a measured parameter related to a remote unit in the DCS exceeds a threshold and, based on the determination, turning off selected antennas in an antenna array at the remote unit. The method further includes serving user equipment using a remainder of the antenna array.

In another aspect, a distributed communication system (DCS) is disclosed. The DCS includes a central unit configured to be coupled to a service provider and at least one remote unit communicatively coupled to the central unit. Responsive to instructions from a control circuit, the remote unit is configured to based on a determination of the control circuit that a parameter associated with the remote unit exceeds a threshold, turn off selected antennas in an antenna array at the remote unit, and serve user equipment using a remainder of the antenna array.

### BRIEF DESCRIPTION OF THE DRAWINGS

FIG. 1 is a block diagram of an exemplary distributed communication system having a link to an external source, a central unit, and a plurality of remote units;

FIG. 2 is a block diagram of a transceiver in a remote unit;

FIG. 3 is a block diagram of an antenna array in a remote unit;

FIG. 4 is a block diagram of an area of coverage for a remote unit;

FIG. 5A illustrates the antenna array of FIG. 3 in normal beam forming operation;

FIG. 5B illustrates the antenna array of FIG. 3 in a modified beam-forming operation after implementation of aspects of the present disclosure;

FIG. 6A is a flowchart illustrating a first exemplary process for managing power consumption in a remote unit according to exemplary aspects of the present disclosure;

FIGS. 6B-8B are flowcharts illustrating alternate exemplary processes for managing power consumption in a remote unit according to exemplary aspects of the present disclosure;

FIG. 9 is a schematic diagram of an exemplary wireless distributed communication system (DCS) in the form of a distributed antenna system (DAS) that may include remote units that are operated according to the power-saving methods of the present disclosure;

FIG. 10 is a partially schematic cut-away diagram of an exemplary building infrastructure in which the DCS in FIG. 9 can be provided;

FIG. 11 is a schematic diagram of an exemplary optical-fiber-based DCS configured to distribute communications signals between a central unit and a plurality of remote units that may be operated according to exemplary aspects of the present disclosure;

FIG. 12 is a schematic diagram of an exemplary mobile telecommunications environment that includes an exemplary radio access network (RAN) that includes a mobile network operator (MNO) macrocell employing a radio node, a shared spectrum cell employing a radio node, an exemplary small cell RAN employing a multi-operator radio node located within an enterprise environment as DCSs, and that can include one or more remote units configured to be operated according to exemplary aspects of the present disclosure;

FIG. 13 is a schematic diagram of an exemplary DCS that supports 4G and 5G communications services that may include a remote unit configured to be operated according to exemplary aspects of the present disclosure; and

FIG. 14 is a schematic diagram of a generalized representation of an exemplary controller that can be included in any component or circuit in a DCS, including the DCS of FIGS. 9-13.

### DETAILED DESCRIPTION

Aspects disclosed in the detailed description include systems and methods for power management in a remote unit. In particular, exemplary aspects of the present disclosure contemplate evaluating parameters and turning off portions of an antenna array associated with the remote unit. Exemplary parameters include signal strengths of active user equipment in a coverage area, a total number of active user equipment, and/or actual signal traffic being generated by/for the active user equipment. Based on one or more of these parameters, certain ones of the antennas and associated transceiver circuitry for the antenna array may be put into a low power or sleep mode. Given that an antenna array may include on the order of sixty-four antennas, and aspects of the present disclosure may put up to half the antennas in the low power mode, substantial power savings may be achieved.

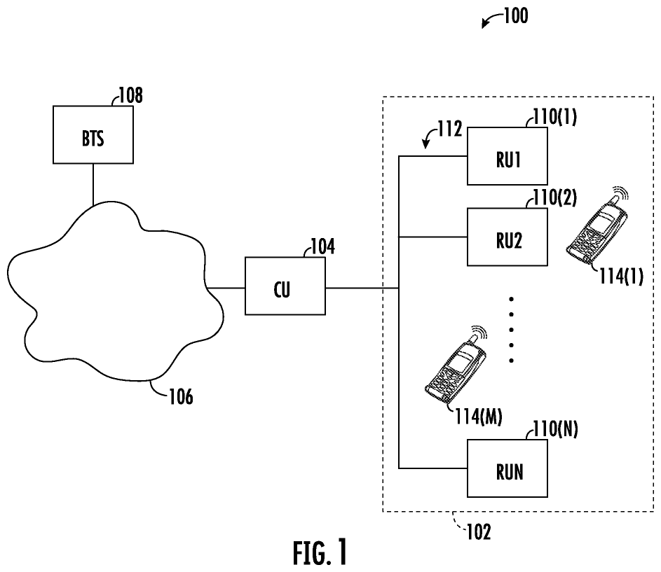

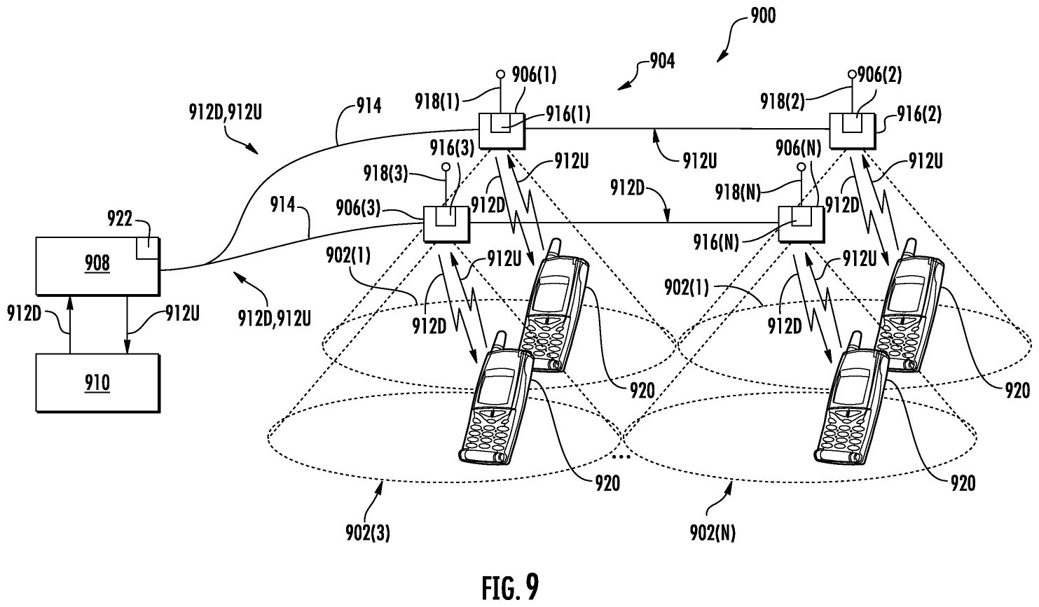

While additional background details about possible distributed communication systems (DCS) are provided below, beginning with reference to FIG. 9, the discussion of exemplary aspects of the present disclosure is facilitated by a brief discussion of a DCS so that the general context is clear. In this regard, FIG. 1 is a simplified block diagram of a DCS 100, which may, for example, be a distributed antenna system (DAS), a radio access network (RAN), a base station transceiver (BTS), small cell, or the like. The DCS 100 may help provide wireless communication services to places that are otherwise unable to receive adequate wireless service (e.g., inside a building 102). The DCS 100 may include a central unit (CU) 104 (sometimes also referred to as a head-end unit (HEU)) that communicates with a service provider through a network 106 and/or a base station 108. The communication between the CU 104 and the service provider is generally wire based but can be wireless and is not central to the present discussion. The CU 104 also communicates with a plurality of remote units (RU) 110(1)-110(N) through an intermediate network 112. Signals pass from the service provider to the CU 104, through the intermediate network 112 to the RU 110(1)-110(N) and are wirelessly transmitted to user equipment (UE) 114(1)-114(M) in various areas of coverage provided by the DCS 100.

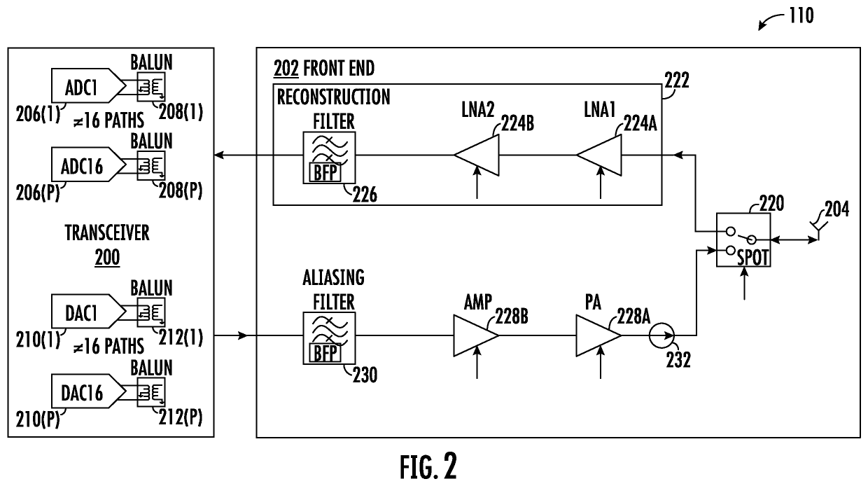

Any given remote unit 110 may have at least one and frequently a plurality of transceiver circuits 200 and front ends 202, as illustrated in FIG. 2. More specifically, for a given antenna 204, the remote unit 110 may include such a transceiver circuit 200 and front end 202. The transceiver circuit 200 may include a first plurality of analog to digital converters (ADC) 206(1)-206(P) with associated baluns 208(1)-208(P). Further, the transceiver circuit 200 may include a second plurality of digital to analog converters (DACs) 210(1)-210(P) with associated baluns 212(1)-212(P). Not shown are baseband processors, mixers, frequency converters, and other circuitry, as is well understood in the art.

With continued reference to FIG. 2, the front end 202 may include a switch 220 that selectively couples a receive chain 222 and a transmit chain 224 to an antenna 226. The switch 220 may be a single pole dual throw switch. The receive chain 222 may include low noise amplifiers 224A, 224B, and a reconstruction filter 226. Other circuit elements may be present as needed or desired. For example, in a frequency division duplexing system, a duplexer (not shown) may be used instead of a switch 220. The transmit chain 224 may include amplifiers 228A, 228B, an aliasing filter 230, and a circulator 232. Again, other circuit elements may be present as needed or desired.

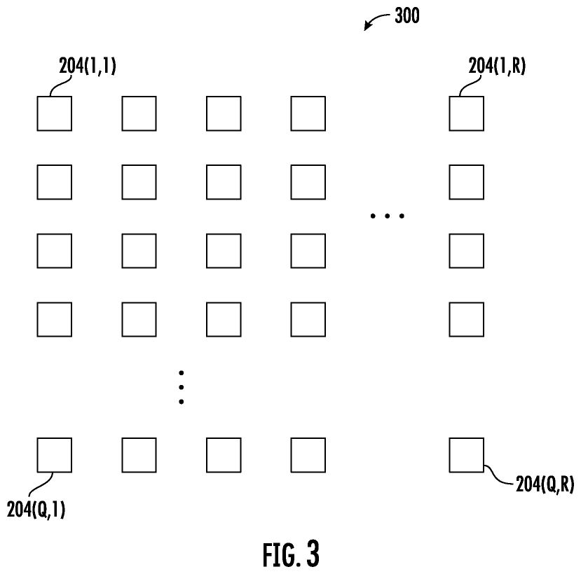

In use, many of these elements are considered active elements and consume power. In isolation, such power use is not critical, but when many such elements are present in a single remote unit 110, the cumulative effect of such myriad elements reflects a substantial power expenditure. In practice, a transceiver circuit 200 and a front end 202 may be present for each antenna 204. When, as illustrated in FIG. 3, a plurality of antennas 204 are assembled into an antenna array 300, the scope of the power consumption may be viewed more objectively as substantial.

In particular, the antenna array 300 may include antennas 204(1,1)-204(Q,R). In many instances, Q=R, but this equivalency need not strictly be required. In an exemplary aspect, Q=R=8, so there are sixty-four individual antennas 204 with a corresponding sixty-four transceiver circuits 200 and front ends 202. As suggested, the cumulative power consumption for a given remote unit 110 is a function of these duplicative circuits. When the number of RUs is large within a DCS 100, the cumulative power consumption may become even more of a burden.

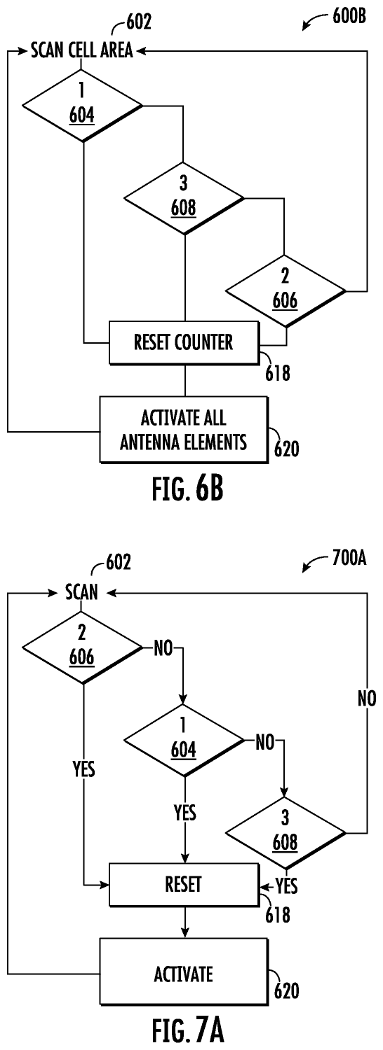

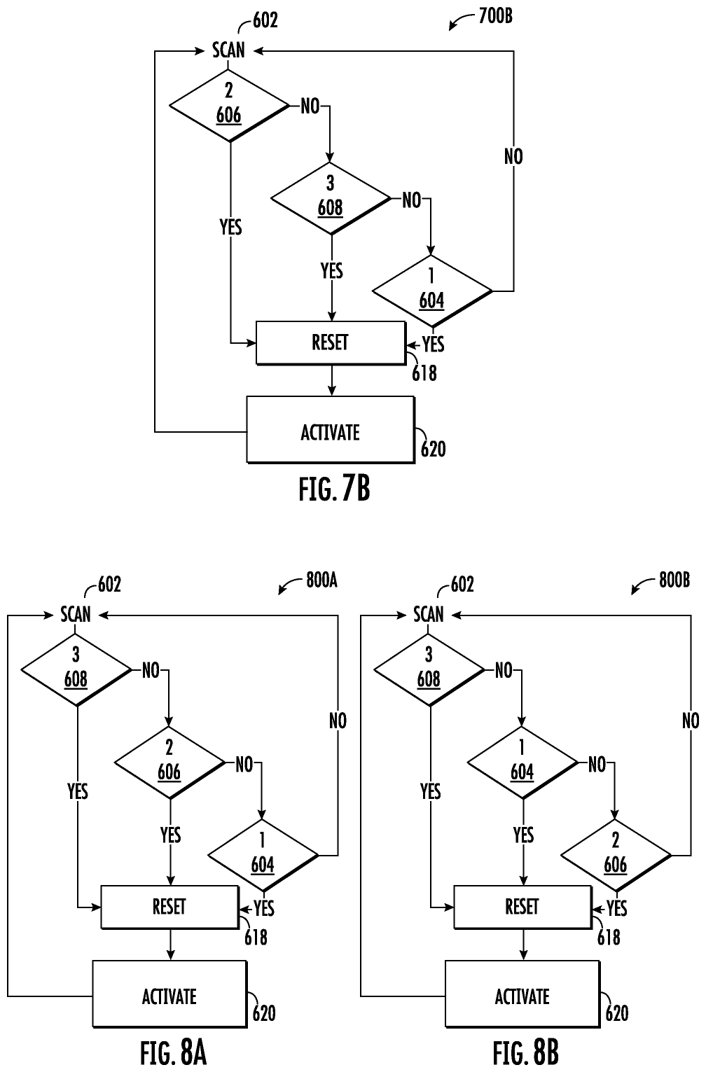

Exemplary aspects of the present disclosure allow certain elements within a given remote unit 110 to be turned off, placed in a low power mode, or placed in a sleep mode to reduce power consumption opportunistically. In exemplary aspects, there are three possible parameters that may be measured to assist in determining when and how to turn off the certain elements. While the specific processes associated with this decision-making are discussed below with reference to the flowcharts of FIGS. 6A-8B, a few additional schematic diagrams are provided and discussed to provide additional context.

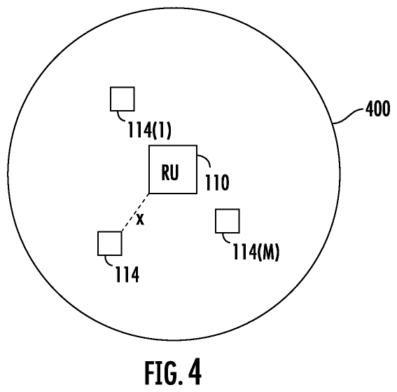

In this regard, FIG. 4 provides a schematic diagram of an area of coverage 400 for a remote unit 110 with various UE 114(1)-114(M) within the area of coverage 400. In general, the shorter the distance X between the remote unit 110 and a UE 114, the lower a signal to interference and noise ratio (SINR (or sometimes just SNR)) will be. An alternate but almost functionally equivalent measurement would be the received signal strength indicator (RSSI) because SNR=RSSI minus background noise. As explained below, if all the SINR for a given area of coverage 400 are adequate, certain ones of the antennas 204(1,1)-204(Q,R) in the antenna array 300 may be turned off. Turning off some antennas 204(1,1)-204(Q,R) allows parts of the corresponding front end 202 and the corresponding transceiver circuit 200 to be turned off as well, affecting the power savings of the present disclosure.

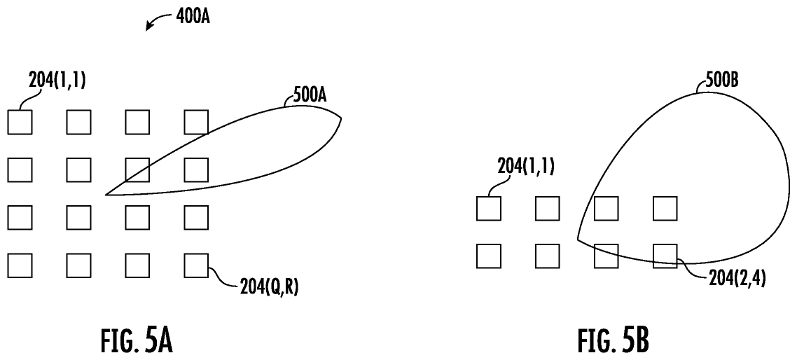

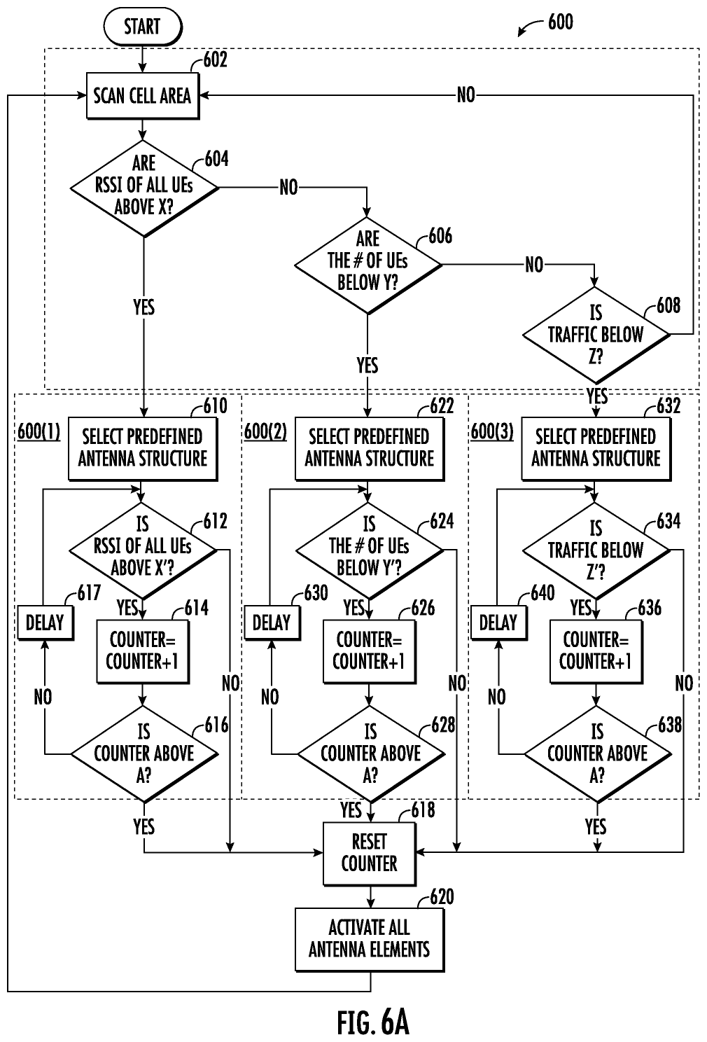

Thus, instead of an antenna array 400A forming a beam 500A, as illustrated in FIG. 5A, when all the antennas 204(1,1)-204(Q,R) are turned on, a wider, less focused beam 500B, as illustrated in FIG. 5B may be formed when only a portion of the antennas 204(1,1)-204(2,4) are active.

While SINR has been listed as one parameter that may be considered in determining what antennas and circuits may be turned off or put into a low power/sleep mode, there are other parameters, and the order in which the parameters are considered may vary depending on design criteria. Specifically, a total number of UE within an area of coverage may be considered and/or low traffic conditions may be considered. This list is not meant to be exclusive, and other parameters may be considered. However, for the sake of an example, the various permutations of these three parameters are provided with reference to the flowcharts of FIGS. 6A-8B.

In this regard, FIG. 6A has a process 600 that starts by scanning the cell area (block 602) or the area of coverage for a remote unit 110. A control circuit determines if the RSSI (or SINR) of all UEs 114(1)-114(M) is above a threshold (block 604) (i.e., is RSSI>X). If the answer is yes, the process 600 begins sub-process 600(1). If the answer is no, the control circuit determines if the total number of UEs 114(1)-114(M) is below a threshold (block 606) (i.e., is M<Y). If the answer to block 606 is yes, then the process 600 begins sub-process 600(2). If the answer is no, the control circuit determines if the traffic level is below some threshold (block 608) (i.e., is traffic<Z). If the answer to block 608 is yes, then the process 600 begins sub-process 600(3). If the answer is no, then the process returns to block 602 and repeats.

Turning now to sub-process 600(1), the control circuit has determined that the conditions are sufficiently good (based on RSSI, SINR, or the like) and selects a predefined antenna structure (block 610) that includes less than all the antennas 204(1)-204(Q,R) in the antenna array 300. Elements associated with used antennas remain active, but elements such as ADCs 206(1)-206(P), DACs 210(1)-210(P), LNA 224A, LNA 224B, amplifiers 228A, 228B associated with unused antennas may be put into a sleep or low power mode (or turned off). The control circuit may check that the RSSI/SINR of all the UE 114(1)-114(M) remains above some threshold (block 612) (which, because of hysteresis will be different from the threshold used in block 604). If the answer is yes, then the control circuit increments a counter (block 614). The control circuit then determines if the counter has exceeded a threshold A (block 616). If the answer is no, then the control circuit executes a delay (block 617) and rechecks the signal strengths (block 612). If the answer to block 612 is no or the answer to block 616 is yes, then the control circuit exits the sub-process 600(1) and resets the counter (block 618) and activates all antenna elements (block 620) before repeating the scan of the cell area (block 602). In this manner, any new UEs 114 that may have entered the cell area may be found or any UE that have moved away from the RU 110 (and have a lower SINR or RSSI) will still receive adequate service.

Similarly, if the answer to block 606 is yes, then the sub-process 600(2) begins by selecting a predefined antenna structure (block 622) which uses less than all the antennas 204(1,1)-204(Q,R). The control circuit determines if the number of UEs 114(1)-114(M) remains below the threshold (block 624). If the answer to block 624 is no, then the sub-process 600(2) exits to block 618. If the answer to block 624 is yes, then the control circuit increments a counter (block 626). The control circuit then determines if the counter is above a threshold (block 628). If the answer to block 628 is yes, then the sub-process 600(2) exits to block 618. If the answer to block 628 is no, then the control circuit executes a delay (block 630) and rechecks the number of UE 114(1)-114(M) at block 622. In this manner, the control circuit may cycle back through and see if there are enough new UE to justify a different antenna pattern.

Similarly, if the answer to block 608 is yes, then the sub-process 600(3) begins by selecting a predefined antenna structure (block 632) which uses less than all the antennas 204(1,1)-204(Q,R). The control circuit determines if the traffic remains below the threshold (block 634). If the answer to block 634 is no, then the sub-process 600(3) exits to block 618. If the answer to block 634 is yes, then the control circuit increments a counter (block 636). The control circuit then determines if the counter is above a threshold (block 638). If the answer to block 638 is yes, then the sub-process 600(3) exits to block 618. If the answer to block 638 is no, then the control circuit executes a delay (block 640) and rechecks the traffic levels at block 632. In this manner, the control circuit may cycle back through and see if there is enough new traffic to justify a different antenna pattern.

FIG. 6B shows a process 600B that is similar to the process 600, but the inquiries of blocks 606 and 608 are inverted with correspondingly inverted entries into the sub-processes 600(2) and 600(3).

FIG. 7A is similar but has a process 700A that begins with an inquiry of block 606 and then checks the inquiries of blocks 604 and 608, respectively. Based on which block is answered affirmatively, one of the sub-processes 600(1)-600(3) is invoked. FIG. 7B has process 700B, which is similar to process 700A, but the inquiries of blocks 608 and 604 are inverted with correspondingly inverted entries into the sub-processes 600(1) and 600(3).

FIG. 8A is similar but has a process 800A that begins with an inquiry of block 608 and then checks the inquiries of blocks 606 and 604, respectively. Based on which block is answered affirmatively, one of the sub-processes 600(1)-600(3) is invoked. FIG. 8B has process 800B, which is similar to process 800A, but the inquiries of blocks 606 and 604 are inverted with correspondingly inverted entries into the sub-processes 600(2) and 600(3).

The above processes 600, 600B, 700A, 700B, 800A, and 800B refer to a control circuit. This control circuit could be located in the RU 110, in the central unit 104, or at the service provider. Necessary and sufficient signals may be exchanged between these elements to effectuate the changes at the RU 110. Such signals may be in-band or out-of-band as needed or desired.

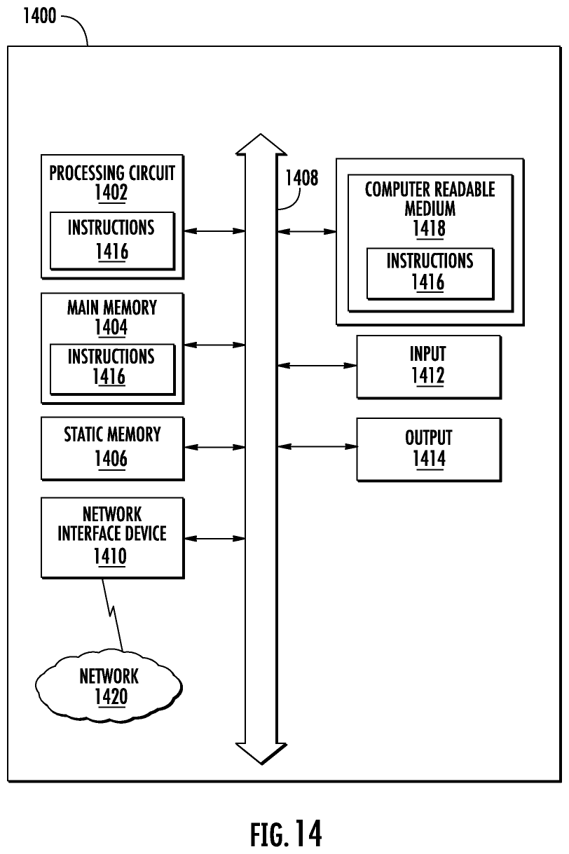

The above discussion has given the general context of how a remote unit may operate within a DCS. In the interests of completeness, a more complete discussion of possible DCS is explored below with reference to FIGS. 9-13 and an exemplary computer that may be used at various locations within such a DCS is illustrated in FIG. 14. It should be appreciated that these details are provided in the interest of full disclosure and are not central to the present disclosure.

In this regard, FIG. 9 illustrates a wireless distributed communication system (WDCS) 900 that is configured to distribute communications services to remote coverage areas 902(1)-902(N), where ‘N’ is the number of remote coverage areas. The WDCS 900 in FIG. 9 is provided in the form of a distributed antenna system (DAS) 904. The DAS 904 can be configured to support a variety of communications services that can include cellular communications services, wireless communications services, such as RF identification (RFID) tracking, Wireless Fidelity (Wi-Fi), local area network (LAN), and wireless LAN (WLAN), wireless solutions (Bluetooth, Wi-Fi Global Positioning System (GPS) signal-based, and others) for location-based services, and combinations thereof, as examples. The remote coverage areas 902(1)-902(N) are created by and centered on remote units 906(1)-906(N) connected to a central unit 908 (e.g., a head-end controller, a central unit, or a head-end unit). The remote units 906(1)-906(N) are analogous to the remote unit 110, described above. The central unit 908 may be communicatively coupled to a source transceiver 910, such as, for example, a base transceiver station (BTS) or a baseband unit (BBU). In this regard, the central unit 908 receives downlink communications signals 912D from the source transceiver 910 to be distributed to the remote units 906(1)-906(N). The downlink communications signals 912D can include data communications signals and/or communication signaling signals, as examples. The central unit 908 is configured with filtering circuits and/or other signal processing circuits that are configured to support a specific number of communications services in a particular frequency bandwidth (i.e., frequency communications bands). The downlink communications signals 912D are communicated by the central unit 908 over a communications link 914 over their frequency to the remote units 906(1)-906(N).

With continuing reference to FIG. 9, the remote units 906(1)-906(N) are configured to receive the downlink communications signals 912D from the central unit 908 over the communications link 914. The downlink communications signals 912D are configured to be distributed to the respective remote coverage areas 902(1)-902(N) of the remote units 906(1)-906(N). The remote units 906(1)-906(N) are also configured with filters and other signal processing circuits that are configured to support all or a subset of the specific communications services (i.e., frequency communications bands) supported by the central unit 908. In a non-limiting example, the communications link 914 may be a wired communications link, a wireless communications link, or an optical fiber-based communications link. Each of the remote units 906(1)-906(N) may include an RF transmitter/receiver 916(1)-916(N) and a respective antenna 918(1)-918(N) operably connected to the RF transmitter/receiver 916(1)-916(N) to distribute wirelessly the communications services to user equipment (UE) 920 within the respective remote coverage areas 902(1)-902(N). The remote units 906(1)-906(N) are also configured to receive uplink communications signals 912U from the UE 920 in the respective remote coverage areas 902(1)-902(N) to be distributed to the source transceiver 910.

Because the remote units 906(1)-906(N) include components that require power to operate, such as the RF transmitter/receivers 916(1)-916(N) for example, it is necessary to provide power to the remote units 906(1)-906(N). In one example, each remote unit 906(1)-906(N) may receive power from a local power source. In another example, the remote units 906(1)-906(N) may be powered remotely from a remote power source(s). For example, the central unit 908 may include a power source 922 that is configured to remotely supply power over the communications links 914 to the remote units 906(1)-906(N). For example, the communications links 914 may be cables that include electrical conductors for carrying current (e.g., direct current (DC)) to the remote units 906(1)-906(N). If the WDCS 900 is an optical fiber-based WDCS in which the communications links 914 include optical fibers, the communications links 914 may be a “hybrid” cable that includes optical fibers for carrying the downlink and uplink communications signals 912D, 912U, and separate electrical conductors for carrying current to the remote units 906(1)-906(N).

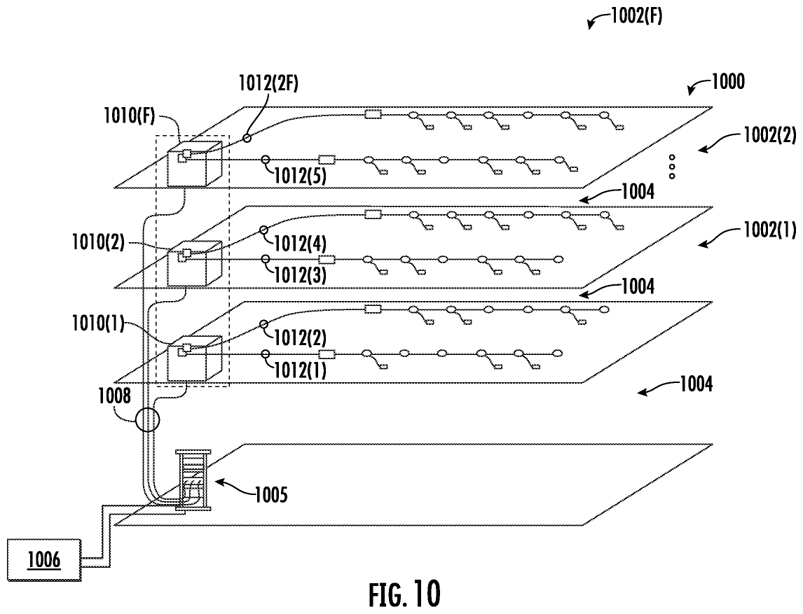

The DAS 904 can be provided in an indoor environment as illustrated in FIG. 10. FIG. 10 is a partially schematic cut-away diagram of a building infrastructure 1000. The building infrastructure 1000 in this embodiment includes a first (ground) floor 1002(1), a second floor 1002(2), and an Fth floor 1002(F), where ‘F’ can represent any number of floors. The floors 1002(1)-1002(F) are serviced by the central unit 908 to provide antenna coverage areas 1004 in the building infrastructure 1000. The central unit 908 is communicatively coupled to a signal source 1006, such as a BTS or BBU, to receive the downlink electrical communications signals. The central unit 908 is communicatively coupled to the remote subunits to receive uplink optical communications signals from the remote subunits. The downlink and uplink optical communications signals are distributed between the central unit 908 and the remote subunits over a riser cable 1008 in this example. The riser cable 1008 may be routed through interconnect units (ICUs) 1010(1)-1010(F) dedicated to each floor 1002(1)-1002(F) for routing the downlink and uplink optical communications signals to the remote subunits. The ICUs 1010(1)-1010(F) may also include respective power distribution circuits that include power sources as part of a power distribution network wherein the power distribution circuits are configured to distribute power remotely to the remote subunits to provide power for operating the power-consuming components in the remote subunits. For example, array cables 1012(1)-1012(2F) may be provided and coupled between the ICUs 1010(1)-1010(F) that contain both optical fibers to provide the respective downlink and uplink optical fiber communications media and power conductors (e.g., electrical wire) to carry current from the respective power distribution circuits to the remote subunits.

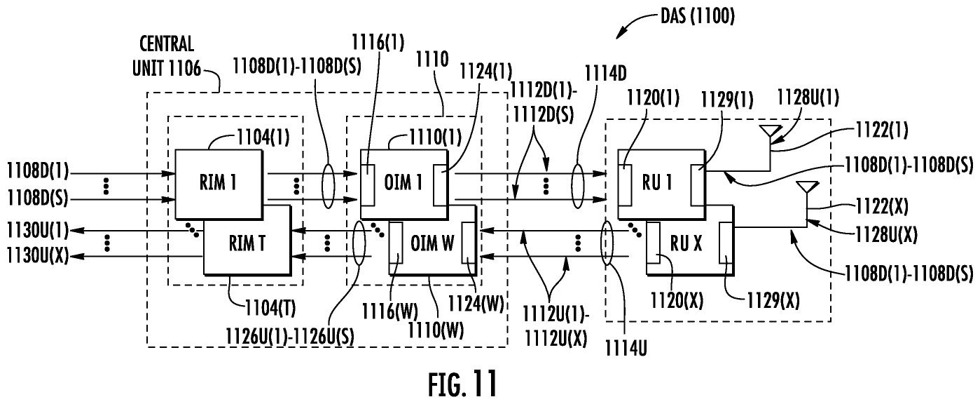

FIG. 11 is a schematic diagram of an exemplary optical fiber-based DAS 1100. As noted above, a DAS is a system that is configured to distribute communications signals, including wireless communications signals, from a central unit to a plurality of remote subunits over physical communications media, to then be distributed from the remote subunits wirelessly to client devices in wireless communication range of a remote subunit. The DAS 1100, in this example, is an optical fiber-based DAS that is comprised of three (3) main components. One or more radio interface circuits provided in the form of radio interface modules (RIMs) 1104(1)-1104(T) are provided in a central unit 1106 to receive and process downlink electrical communications signals 1108D(1)-1108D(S) prior to optical conversion into downlink optical communications signals. The downlink electrical communications signals 1108D(1)-1108D(S) may be received from a base transceiver station (BTS) or baseband unit (BBU) as examples. The downlink electrical communications signals 1108D(1)-1108D(S) may be analog signals or digital signals that can be sampled and processed as digital information. The RIMs 1104(1)-1104(T) provide both downlink and uplink interfaces for signal processing. The notations “1−S” and “1−T” indicate that any number of the referenced component, 1−S and 1−T, respectively, may be provided.

With continuing reference to FIG. 11, the central unit 1106 is configured to accept the plurality of RIMs 1104(1)-1104(T) as modular components that can easily be installed and removed or replaced in a chassis. In one embodiment, the central unit 1106 is configured to support up to twelve (12) RIMs 1104(1)-1104(12). Each RIM 1104(1)-1104(T) can be designed to support a particular type of radio source or range of radio sources (i.e., frequencies) to provide flexibility in configuring the central unit 1106 and the DAS 1100 to support the desired radio sources. For example, one RIM 1104(1)-1104(T) may be configured to support the Personal Communication Services (PCS) radio band. Another RIM 1104(1)-1104(T) may be configured to support the 700 MHz radio band. In this example, by the inclusion of these RIMs 1104(1)-1104(T), the central unit 1106 could be configured to support and distribute communications signals, including those for the communications services and communications bands described above as examples.

The RIMs 1104(1)-1104(T) may be provided in the central unit 1106 that support any frequencies desired, including, but not limited to, licensed US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), C-Band frequencies (3450-3980 MHz), and US FCC frequencies (2495-2690 MHz on uplink and downlink).

With continuing reference to FIG. 11, the received downlink electrical communications signals 1108D(1)-1108D(S) are provided to a plurality of optical interfaces provided in the form of optical interface modules (OIMs) 1110(1)-1110(W) in this embodiment to convert the downlink electrical communications signals 1108D(1)-1108D(S) into downlink optical communications signals 1112D(1)-1112D(S). The notation “1−W” indicates that any number of the referenced component 1−W may be provided. The OIMs 1110(1)-1110(W) may include one or more optical interface components (OICs) that contain electrical-to-optical (E-O) converters 1116(1)-1116(W) to convert the received downlink electrical communications signals 1108D(1)-1108D(S) into the downlink optical communications signals 1112D(1)-1112D(S). The OIMs 1110(1)-1110(W) support the radio bands that can be provided by the RIMs 1104(1)-1104(T), including the examples previously described above. The downlink optical communications signals 1112D(1)-1112D(S) are communicated over a downlink optical fiber communications link 1114D to a plurality of remote subunits (e.g., remote subunits 404) provided in the form of remote subunits in this example. The notation “1-X” indicates that any number of the referenced component 1−X may be provided. One or more of the downlink optical communications signals 1112D(1)-1112D(S) can be distributed to each remote subunit. Thus, the distribution of the downlink optical communications signals 1112D(1)-1112D(S) from the central unit 1106 to the remote subunits is in a point-to-multipoint configuration in this example.

With continuing reference to FIG. 11, the remote subunits include optical-to-electrical (O-E) converters 1120(1)-1120(X) configured to convert the one or more received downlink optical communications signals 1112D(1)-1112D(S) back into the downlink electrical communications signals 1108D(1)-1108D(S) to be wirelessly radiated through antennas 1122(1)-1122(X) in the remote subunits to user equipment (not shown) in the reception range of the antennas 1122(1)-1122(X). The OIMs 1110(1)-1110(W) may also include O-E converters 1124(1)-1124(W) to convert received uplink optical communications signals 1112U(1)-1112U(X) from the remote subunits into uplink electrical communications signals 1126U(1)-1126U(X) as will be described in more detail below.

With continuing reference to FIG. 11, the remote subunits are also configured to receive uplink electrical communications signals 1128U(1)-1128U(X) received by the respective antennas 1122(1)-1122(X) from client devices in wireless communication range of the remote subunits. The uplink electrical communications signals 1128U(1)-1128U(X) may be analog signals or digital signals that can be sampled and processed as digital information. The remote subunits include E-O converters 1129(1)-1129(X) to convert the received uplink electrical communications signals 1128U(1)-1128U(X) into uplink optical communications signals 1112U(1)-1112U(X). The remote subunits distribute the uplink optical communications signals 1112U(1)-1112U(X) over an uplink optical fiber communications link 1114U to the OIMs 1110(1)-1110(W) in the central unit 1106. The O-E converters 1124(1)-1124(W) convert the received uplink optical communications signals 1112U(1)-1112U(X) into uplink electrical communications signals 1130U(1)-1130U(X), which are processed by the RIMs 1104(1)-1104(T) and provided as the uplink electrical communications signals 1130U(1)-1130U(X) to a source transceiver such as a BTS or BBU.

Note that the downlink optical fiber communications link 1114D and the uplink optical fiber communications link 1114U coupled between the central unit 1106 and the remote subunits may be a common optical fiber communications link, wherein for example, wave division multiplexing (WDM) may be employed to carry the downlink optical communications signals 1112D(1)-1112D(S) and the uplink optical communications signals 1112U(1)-1112U(X) on the same optical fiber communications link. Alternatively, the downlink optical fiber communications link 1114D and the uplink optical fiber communications link 1114U coupled between the central unit 1106 and the remote subunits may be single, separate optical fiber communications links, wherein for example, wave division multiplexing (WDM) may be employed to carry the downlink optical communications signals 1112D(1)-1112D(S) on one common downlink optical fiber and the uplink optical communications signals 1112U(1)-1112U(X) on a separate, only uplink optical fiber. Alternatively, the downlink optical fiber communications link 1114D and the uplink optical fiber communications link 1114U coupled between the central unit 1106 and the remote subunits may be separate optical fibers dedicated to and providing a separate communications link between the central unit 1106 and each remote subunit.

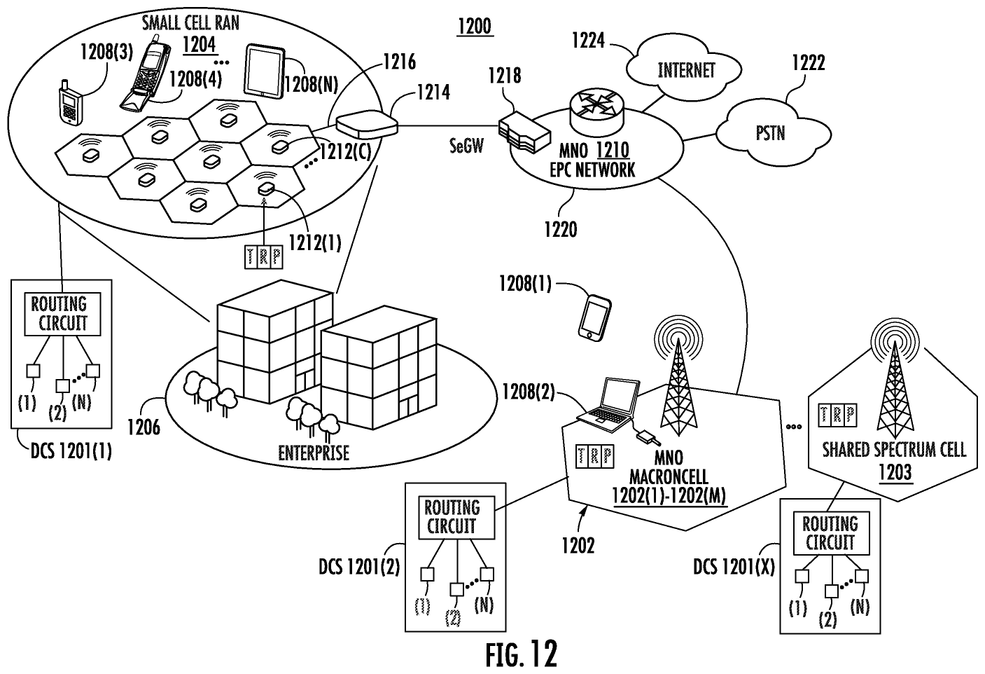

In contrast to the DAS of FIGS. 9-11, FIG. 12 is a schematic diagram of an exemplary mobile telecommunications environment 1200 that includes an exemplary radio access network (RAN) that includes a mobile network operator (MNO) macrocell employing a radio node, a shared spectrum cell employing a radio node, an exemplary small cell RAN employing a multi-operator radio node located within an enterprise environment as DCSs. The environment 1200 includes exemplary macrocell RANs 1202(1)-1202(M) (“macrocells 1202(1)-1202(M)”) and an exemplary small cell RAN 1204 located within an enterprise environment 1206 and configured to service mobile communications between a user mobile communications device 1208(1)-1208(N) to an MNO 1210. A serving RAN for a user mobile communications device 1208(1)-1208(N) is a RAN or cell in the RAN in which the user mobile communications devices 1208(1)-1208(N) have an established communications session with the exchange of mobile communications signals for mobile communications. Thus, a serving RAN may also be referred to herein as a serving cell. For example, the user mobile communications devices 1208(3)-1208(N) in FIG. 12 are being serviced by the small cell RAN 1204, whereas user mobile communications devices 1208(1) and 1208(2) are being serviced by the macrocell 1202. The macrocell 1202 is an MNO macrocell in this example. However, a shared spectrum RAN 1203 (also referred to as “shared spectrum cell 1203”) includes a macrocell in this example and supports communications on frequencies that are not solely licensed to a particular MNO and thus may service user mobile communications devices 1208(1)-1208(N) independent of a particular MNO. For example, the shared spectrum cell 1203 may be operated by a third party that is not an MNO and wherein the shared spectrum cell 1203 supports Citizen Broadband Radio Service (CBRS). Also, as shown in FIG. 12, the MNO macrocell 1202, the shared spectrum cell 1203, and/or the small cell RAN 1204 can interface with one or more shared spectrum DCSs 1201(1)-1201(X) supporting coordination of distribution of shared spectrum from multiple service providers to remote subunits to be distributed to subscriber devices. The MNO macrocell 1202, the shared spectrum cell 1203, and the small cell RAN 1204 may be neighboring radio access systems to each other, meaning that some or all can be in proximity to each other such that a user mobile communications device 1208(1)-1208(N) may be able to be in communications range of two or more of the MNO macrocell 1202, the shared spectrum cell 1203, and the small cell RAN 1204 depending on the location of user mobile communications devices 1208(1)-1208(N).

In FIG. 12, the mobile telecommunications environment 1200 in this example is arranged as an LTE (Long Term Evolution) system as described by the Third Generation Partnership Project (3GPP) as an evolution of the GSM/UMTS standards (Global System for Mobile Communication/Universal Mobile Telecommunications System). However, it is emphasized that the aspects described herein may also apply to other network types and protocols. The mobile telecommunications environment 1200 includes the enterprise environment 1206 in which the small cell RAN 1204 is implemented. The small cell RAN 1204 includes a plurality of small cell radio nodes 1212(1)-1212(C). Each small cell radio node 1212(1)-1212(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated. A small cell radio node RAN may be or include the remote unit operated according to the present disclosure.

In FIG. 12, the small cell RAN 1204 includes one or more service nodes (represented as a single service node 1214) that manage and control the small cell radio nodes 1212(1)-1212(C). In alternative implementations, the management and control functionality may be incorporated into a radio node, distributed among nodes, or implemented remotely (i.e., using infrastructure external to the small cell RAN 1204). The small cell radio nodes 1212(1)-1212(C) are coupled to the services node 1214 over a direct or local area network (LAN) connection 1216 as an example, typically using secure IPsec tunnels. The small cell radio nodes 1212(1)-1212(C) can include multi-operator radio nodes. The services node 1214 aggregates voice and data traffic from the small cell radio nodes 1212(1)-1212(C) and provides connectivity over an IPsec tunnel to a security gateway (SeGW) 1218 in a network 1220 (e.g., evolved packet core (EPC) network in a 4G network, or 5G Core in a 5G network) of the MNO 1210. The network 1220 is typically configured to communicate with a public switched telephone network (PSTN) 1222 to carry circuit-switched traffic, as well as for communicating with an external packet-switched network such as the Internet 1224.

The environment 1200 also generally includes a node (e.g., eNodeB or gNodeB) base station, or “macrocell” 1202. The radio coverage area of the macrocell 1202 is typically much larger than that of a small cell, where the extent of coverage often depends on the base station configuration and the surrounding geography. Thus, a given user mobile communications device 1208(1)-1208(N) may achieve connectivity to the network 1220 (e.g., EPC network in a 4G network or 5G Core in a 5G network) through either a macrocell 1202 or small cell radio node 1212(1)-1212(C) in the small cell RAN 1204 in the environment 1200.

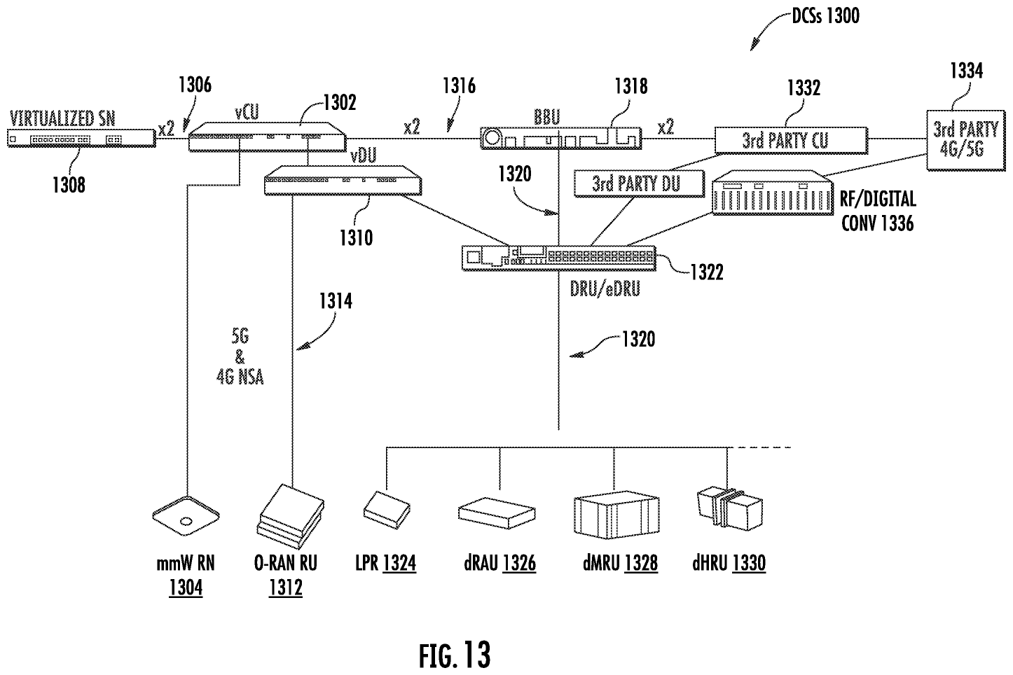

FIG. 13 is a schematic diagram illustrating alternate possible DCSs 1300 that support 4G and 5G communications services. The DCSs 1300 support both legacy 4G LTE, 4G/5G non-standalone (NSA), and 5G communications systems. As shown in FIG. 13, a centralized services node 1302 is provided that is configured to interface with a core network to exchange communications data and distribute the communications data as radio signals to remote subunits. In this example, the centralized services node 1302 is configured to support distributed communications services to a millimeter wave (mmW) radio node 1304. The functions of the centralized services node 1302 can be virtualized through an x2 interface 1306 to another services node 1308. The centralized services node 1302 can also include one or more internal radio nodes that are configured to be interfaced with a distribution node 1310 to distribute communications signals for the radio nodes to an open RAN (O-RAN) remote unit 1312 that is configured to be communicatively coupled through an O-RAN interface 1314.

The centralized services node 1302 can also be interfaced through an x2 interface 1316 to a BBU 1318 that can provide a digital signal source to the centralized services node 1302. The BBU 1318 is configured to provide a signal source to the centralized services node 1302 to provide radio source signals 1320 to the O-RAN remote unit 1312 as well as to a distributed router unit (DRU) 1322 as part of a digital DAS. The DRU 1322 is configured to split and distribute the radio source signals 1320 to different types of remote subunits, including a lower-power remote unit (LPR) 1324, a radio antenna unit (dRAU) 1326, a mid-power remote unit (dMRU) 1328, and a high-power remote unit (dHRU) 1330. The BBU 1318 is also configured to interface with a third-party central unit 1332 and/or an analog source 1334 through a radio frequency (RF)/digital converter 1336.

FIG. 14 is a schematic diagram representation of additional detail illustrating a computer system 1400 that could be employed in any component or circuit in a DCS. In this regard, the computer system 1400 is adapted to execute instructions from an exemplary computer-readable medium to perform these and/or any of the functions or processing described herein. The computer system 1400 in FIG. 14 may include a set of instructions that may be executed to program and configure programmable digital signal processing circuits in a DCS for supporting the scaling of supported communications services. The computer system 1400 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 1400 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server or a user's computer.

The exemplary computer system 1400 in this embodiment includes a processing device or processor 1402, a main memory 1404 (e.g., read-only memory (ROM), flash memory, dynamic random access memory (DRAM), such as synchronous DRAM (SDRAM), etc.), and a static memory 1406 (e.g., flash memory, static random access memory (SRAM), etc.), which may communicate with each other via a data bus 1408. Alternatively, the processor 1402 may be connected to the main memory 1404 and/or static memory 1406 directly or via some other connectivity means. The processor 1402 may be a controller, and the main memory 1404 or static memory 1406 may be any type of memory.

The processor 1402 represents one or more general-purpose processing devices, such as a microprocessor, central processing unit, or the like. More particularly, the processor 1402 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processor 1402 is configured to execute processing logic in instructions for performing the operations and steps discussed herein.

The computer system 1400 may further include a network interface device 1410. The computer system 1400 also may or may not include an input 1412, configured to receive input and selections to be communicated to the computer system 1400 when executing instructions. The computer system 1400 also may or may not include an output 1414, including, but not limited to, a display, a video display unit (e.g., a liquid crystal display (LCD) or a cathode ray tube (CRT)), an alphanumeric input device (e.g., a keyboard), and/or a cursor control device (e.g., a mouse).

The computer system 1400 may or may not include a data storage device that includes instructions 1416 stored in a computer-readable medium 1418. The instructions 1416 may also reside, completely or at least partially, within the main memory 1404 and/or within the processor 1402 during execution thereof by the computer system 1400, the main memory 1404 and the processor 1402 also constituting computer-readable medium. The instructions 1416 may further be transmitted or received over a network 1420 via the network interface device 1410.

While the computer-readable medium 1418 is shown in an exemplary embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product or software that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read-only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware and may reside, for example, in Random Access Memory (RAM), flash memory, Read-Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modification combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A method of saving power in a distributed communication system (DCS), comprising:
determining if a measured parameter related to a remote unit in the DCS exceeds a threshold;
based on the determining, turning off selected antennas in an antenna array at the remote unit; and
serving user equipment using a remainder of the antenna array.

2. The method of claim 1, further comprising periodically activating all antenna elements of the antenna array.

3. The method of claim 2, further comprising, after activating all antenna elements, rescanning for user equipment to reevaluate the parameter.

4. The method of claim 1, further comprising measuring the parameter.

5. The method of claim 4, wherein measuring the parameter comprises determining a single-to-interference noise ratio (SINR) for each user equipment in an area of coverage associated with the remote unit.

6. The method of claim 4, wherein measuring the parameter comprises determining a received signal strength indicator (RSSI) for each user equipment in an area of coverage associated with the remote unit.

7. The method of claim 4, wherein measuring the parameter comprises counting a number of user equipment in an area of coverage associated with the remote unit.

8. The method of claim 4, wherein measuring the parameter comprises determining an overall traffic volume associated with an area of coverage associated with the remote unit.

9. The method of claim 1, wherein turning off selected antennas in the antenna array at the remote unit comprises changing a beam shape for the antenna array.

10. The method of claim 1, wherein turning off selected antennas in the antenna array at the remote unit comprises changing a coverage area for the antenna array.

11. The method of claim 2, further comprising user a counter to determine periodicity.

12. A distributed communication system (DCS) comprising:
a central unit configured to be coupled to a service provider; and
at least one remote unit communicatively coupled to the central unit, the remote unit configured, responsive to instructions from a control circuit, to:
based on a determination of the control circuit that a parameter associated with the remote unit exceeds a threshold, turn off selected antennas in an antenna array at the remote unit; and
serve user equipment using a remainder of the antenna array.

13. The DCS of claim 12, wherein the DCS comprises a distributed antenna system.

14. The DCS of claim 12, wherein the DCS comprises a radio access network.

15. The DCS of claim 12, wherein the control circuit is collocated with the at least one remote unit.

16. The DCS of claim 12, wherein the control circuit is collocated with the central unit.

17. The DCS of claim 12, wherein the control circuit is associated with the service provider.

18. The DCS of claim 12, wherein the remote unit comprises the antenna array.

19. The DCS of claim 12, wherein the parameter comprises one or more of a signal interference noise ratio (SINR), received signal strength indicator (RSSI), number of user equipment in an area of coverage, and traffic volume for an area of coverage.
